(19) United States
(12) Patent Application Publication
(10) Pub. No.: US 2003/0222162 A1
(43) Pub. Date: Dec. 4, 2003

(54) Garlic crusher

(76) Inventor: Marcel Klamer, Hamburg (DE)

Correspondence Address: RABIN & BERDO, P.C., Suite 500, 1101 14th Street, N.W., Washington, DC, 20005, US

(21) Appl. No.: 10/435,244

(22) Filed: May 12, 2003

(30) Foreign Application Priority Data
May 31, 2002 (CN) 02237023.4

(51) Int. Cl. A47J 42/00

(52) U.S. Cl. 241/95; 241/169.2

(57) ABSTRACT

A garlic crusher is composed of a upper pressing on which is disposed a pressing block, a lower pressing piece on which is disposed a garlic-pressing groove for accepting the pressing block, and a through-hole-matrix metal sheet. Using a pintle, the corresponding ends respectively of the upper and the lower pressing piece are connected to be a hinge joint. The garlic-pressing groove is disposed at one end of the lower pressing piece near the pintle, and formed by the downward through-aperture on the lower pressing piece and a through-hole-matrix metal sheet, which is inserted into the lower pressing piece through an inserting slot to take its position just above the widow disposed on the lower pressing piece. The garlic crusher is quite convenient in installation and in operation.

### FIELD OF THE INVENTION

The invention generally relates to a food-processing appliance, and specially relates to a garlic crusher.

### BACKGROUND OF THE INVENTION

The garlic is a seasoning food good for the human health. As using for food, the garlic always has to be crushed. The crushed garlic also may be used as a medicine to diminish inflammation and to eliminate toxins. For crushing the garlic, a pressing clamp type of garlic crusher already was developed. It is basically composed of an upper pressing piece on which is disposed a pressing block, a lower pressing piece on which is disposed a garlic-receiving groove able to accept the pressing block, and a pintle by which the corresponding ends respectively of the upper and the lower pressing piece are connected to be a hinge joint. On the bottom surface of the garlic-receiving groove are disposed lots of through holes. Lifting the upper pressing piece to cause its pressing block out of the lower pressing piece, then the garlic clove(s) may be put into the garlic-receiving groove. When the upper pressing piece is pushed down and engaged with the lower pressing piece by hand, the pressing block may be just inserted into the garlic-pressing groove. The garlic clove(s) will be crushed and squeezed out of the through holes disposed on the bottom of the garlic-receiving groove to fall down into a prepared container, so that the garlic mousse is obtained. The garlic mousse may be used for food or for other purposes. But such a garlic crusher has following deficiencies:

1. The diameter of the through holes disposed on the bottom of the garlic-pressing groove is fixed, so as the shredded garlic's thickness of the garlic mousse is unable to be varied for different persons or to be varied for different demands, thus the garlic mousse made by the garlic crusher in prior art cannot meet various requirements;

2. When the processing of garlic mousse is ended, the remainder of garlic mousse cannot be conveniently scrapped off to fall into the container from the bottom surface of the lower pressing piece, thus it will cause waste of raw material or cause elaborate operation when scrapping.

### BRIEF DESCRIPTION OF THE INVENTION

The technical problems having to be solved by the invention are to overcome aforesaid technical deficiencies in prior art and to provide a garlic crusher which can prepare the garlic mousse with various thickness, namely the diameter of shredded garlic to form the garlic mousse may be thick or thin as required, and cause the remainder of garlic mousse able to be conveniently scrapped off to fall into the container.

In the case of the invention, the technical plan for solving aforesaid problems in prior art is as follows:

A garlic crusher is composed of an upper pressing piece on which is disposed a pressing block, a lower pressing piece on which is disposed a garlic-pressing groove for accepting the pressing block, and a pintle by which the corresponding end of the upper pressing piece and that of the lower pressing piece are connected to be a hinge jointed, so as both the pressing pieces may rotate round the pintle. It is characterized by that aforesaid garlic-pressing groove is disposed at one end of the lower pressing piece near to the pintle, and formed by the downward through-aperture on the lower pressing piece and a through-hole-matrix metal sheet which is inserted in through an inserting slot to take its position just above the window disposed on the bottom surface of the lower pressing piece.

On the bottom surface of aforesaid lower pressing piece is disposed a T-shaped slot. Besides a great many of through-holes disposed on the flat metal sheet and closely arranged to be a through-hole matrix, at the end of the through-hole-matrix metal sheet also is disposed a handle. On the top surface of the handle is disposed a T-shaped tab. Once the T-shaped tab is inserted into the T-shaped slot through its transversal part used as an entrance for the T-shaped tab, then the through-hole-matrix metal sheet may be inserted into the lower pressing piece through the inserting slot. The T-shaped tab may be moved forward in the T-shaped slot along with the through-hole-matrix metal sheet being pushed forward in the lower pressing piece. When the through-hole-matrix metal sheet is inserted to take its position and firmly jammed, a garlic-pressing groove will be formed by the positioned through-hole-matrix metal sheet and the downward through-aperture on the lower pressing piece.

At another end of aforesaid lower pressing piece far away from the pintle, are disposed a storage groove and a clip holder, a standby through-hole-matrix metal sheet with a through-hole diameter different form that of aforesaid inserted in metal sheet, may be placed in the storage. groove and tightly clamped on the clip holder.

The height of aforesaid inserting slot must be determined in correspondence to the thickness of the through-hole-matrix metal sheet, so that both of them are in a close sliding fit state.

### BRIEF DESCRIPTION OF THE APPENDED DRAWINGS

FIG. 1 is a perspective schematic diagram of a better embodiment of the garlic crusher in opening state of the invention.

FIG. 2 is an exploded perspective schematic diagram of a better embodiment of the garlic crusher in opening state of the invention.

FIG. 3 is a sectional schematic diagram of a better embodiment of the garlic crusher of the invention.

FIG. 4 is an exploded perspective schematic diagram of a better embodiment of the garlic crusher in opening state of the invention, which is shown from another angle of view.

FIG. 5 is an assembled perspective schematic diagram of FIG. 4.

FIGS. 6A-6E show views of through-hole-matrix metal sheet of a better embodiment of the garlic crusher of the invention.

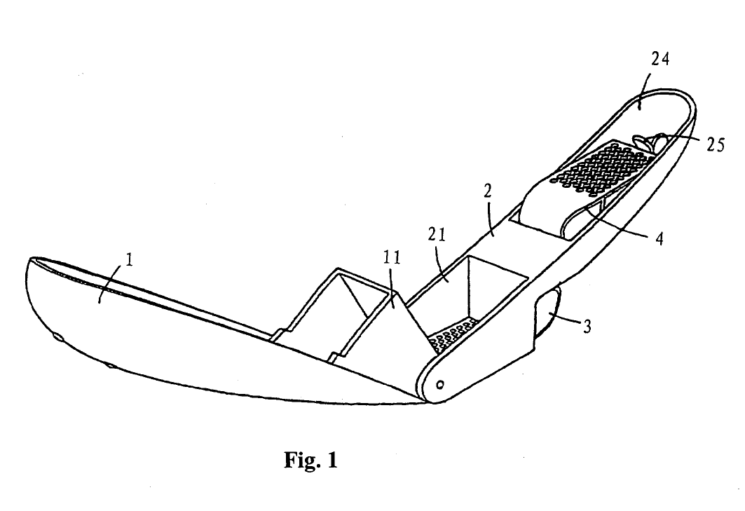

In these FIG. 1 is an upper pressing piece; 11 is a pressing block; 2 is a lower pressing piece; 21 is a garlic-pressing groove; 22 is a window; 23 is an inserting slot for the through-hole-matrix metal sheet 3; 24 is a storage groove for storing standby through-hole-matrix metal sheet 4; 25 is a clip holder for clamping standby through-hole-matrix metal sheet 4; 26 is an entrance of T-shaped slot for inserting T-shaped tab 32; 27 is a T-shaped slot; 3 is a through-hole-matrix metal sheet; 31 is a handle on the through-hole-matrix metal sheet 3; 32 is the T-shaped tab which may slide in T-shaped slot 27; 33 is through-hole; 4 is a standby through-hole-matrix metal sheet; 5 is a pintle.

### DETAILED DESCRIPTION OF THE INVENTION

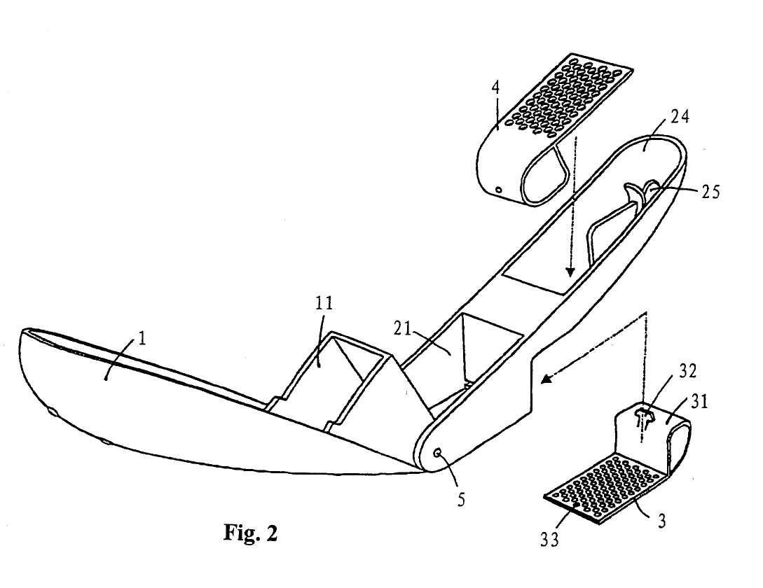

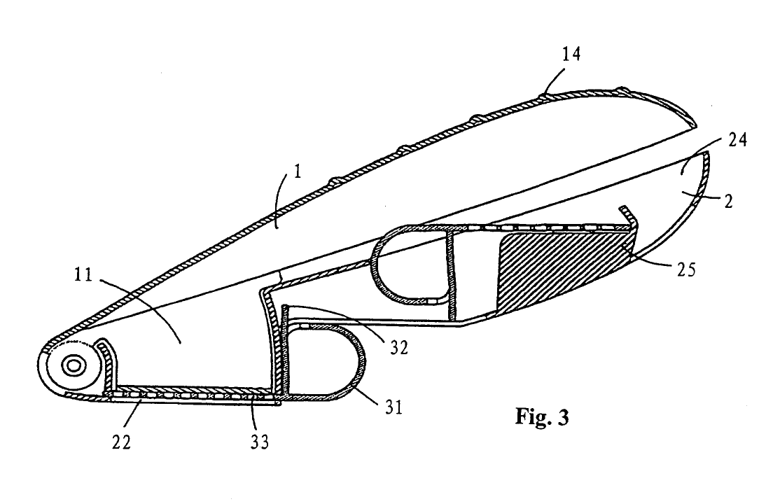

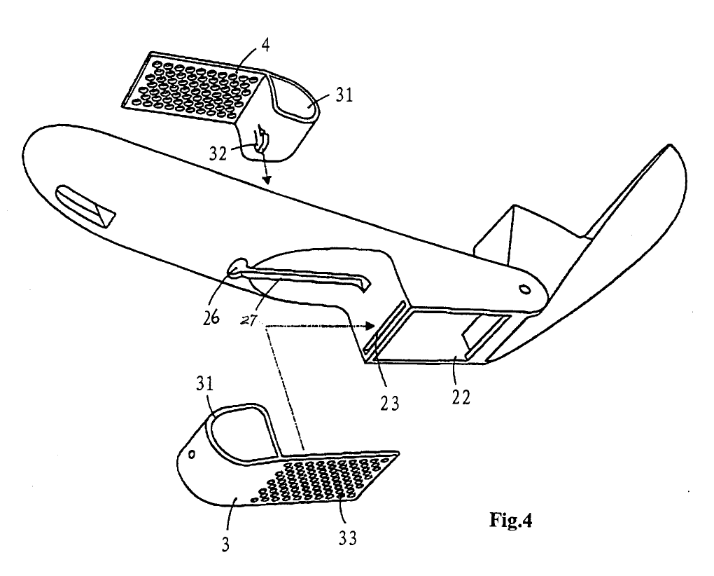

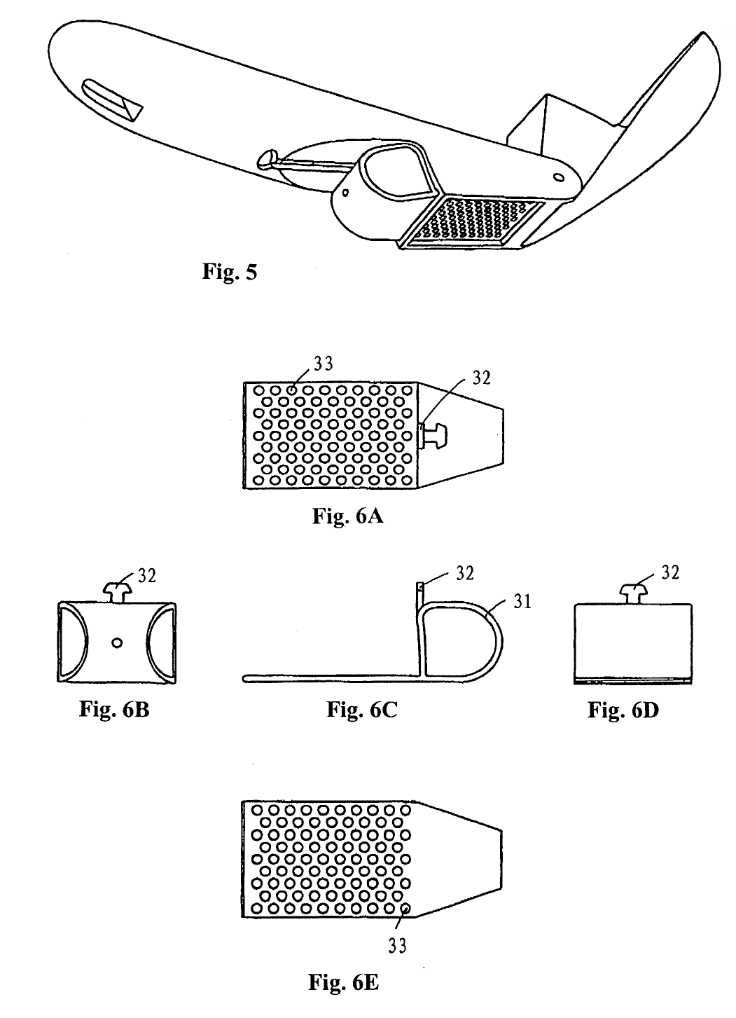

Referring to FIGS. 1 to 6E, from these Figures it may be seen that the garlic crusher of the invention is composed of a upper pressing piece 1, a lower pressing piece 2 and a through-hole-matrix metal sheet 3. Using a pintle 5, the upper pressing piece 1 and the lower pressing piece 2 are connected to be a hinge joint. At one end of the upper pressing piece 1 near the pintle 5 is disposed a pressing block 11. At one end of the lower pressing piece 2 near the pintle 5 and corresponding to the position of the pressing block 11 is disposed a garlic-pressing groove 21 for accepting the pressing block 11. The garlic-pressing groove 21 is formed from the downward through-aperture on the lower pressing piece 2 and a metal sheet 3 having a great many of through-holes 33 closely arranged to be a through-hole matrix thereon (i.e. the through-hole-matrix metal sheet), which is inserted through an inserting slot 23 to take its position just above the window 22 on the bottom surface of the lower pressing piece 2. When the upper pressing piece 1 is pressed downward and engaged with the lower pressing piece 2, the pressing block 11 disposed on the upper pressing piece 1 will gradually and deeply enter the garlic-pressing groove 21 on the lower pressing piece 2. The pressing block 11 will be entirely pressed against the through-hole-matrix metal sheet 3 as both the upper and the lower pressing piece are pressed to be closed.

Besides a great many of through-holes 33 disposed on the flat metal sheet and closely arranged to be a through-hole matrix, for facilitating to remove and replace the inserted through-hole-matrix metal sheet 3, a part of the flat metal sheet at the end outside the lower pressing piece 2 is warped to form a handle 31 as shown in FIGS. 6A-6E. On the top surface of the handle 31 is dispose a T-shaped tab 32. Once the T-shaped tab 32 is inserted into the T-shaped slot 27 through an entrance 26 of T-shaped slot 27for T-shaped tab 32, the through-hole-matrix metal sheet 3 then may be inserted into the lower pressing piece 2 through the inserting slot 23. The T-shaped tab may be moved forward in the T-shaped slot 27 along with the through-hole-matrix metal sheet 3 being pushed forward in the lower pressing piece 2. When the through-hole-matrix metal sheet 3 is pushed to take its operational position and firmly jammed there, a garlic-pressing groove 21 will be formed by the positioned through-hole-matrix metal sheet 3 and the downward through-aperture on the lower pressing piece 2. If necessary, the inserted through-hole-matrix metal sheet 3 may be removed from the lower pressing piece 2 by holding the handle 31 with hand and drawing it out along a suitable direction.

In order that the shredded garlic of the obtained garlic mousse has a different thickness, the originally inserted through-hole-matrix metal sheet may be replaced with another one having desired through-hole diameter other than that of the originally inserted one. In the garlic crusher of the invention, besides one through-hole-matrix metal sheet 3 is mounted in the garlic-pressing groove 21, in the storage groove 24 at another end of the lower pressing piece 2 is stored another one through-hole-matrix metal sheets 3 (i.e. standby through-hole-matrix metal sheet) which is firmly clamped on a clip holder to prevent it falling down from storage groove 24 due to the weight of itself. The through-hole diameters of these two through-hole-matrix metal sheets 3 are different each other, one of the through-hole diameter is suitable for preparing thick shredded garlic and another one suitable for preparing thin shredded garlic. According to the requirement, the originally inserted through-hole-matrix metal sheet may be drawn out of the lower pressing piece and replaced with the standby through-hole-matrix metal sheet, as said above the operation for replacement is quite convenient.

The processing steps of the garlic crusher of the invention are as follows:

1. According to requirement, through inserting slot 23 inserting through-hole-matrix metal sheet 3 with large or small through-hole diameter into lower pressing piece 2, pushing it to take its position and firmly jamming it there;

2. Putting garlic clove(s) desired to be crushed into garlic-pressing groove 21;

3. Taking garlic crusher to a position just above a prepared container, pressing upper pressing piece 2 downward to engage with lower pressing piece 2, crushing garlic clove(s) to be garlic mousse by pressing block 11 and forcing. garlic mousse to fall into container from through-holes 33;

4. Lifting upper pressing piece 1 off, putting other garlic clove(s) into garlic-pressing groove 21, crushing garlic clove(s) to be garlic mousse again and forcing garlic mousse to fall into container from through holes 33;

Repeating steps 1 to 4 until the prepared garlic cloves all are crushed to be garlic mousse;

5. When the processing of garlic mousse is ended, drawing through-hole-matrix metal sheet 3 out of lower pressing piece 2 from slot 23, in the meantime all the garlic mousse remainder on metal sheet being scrapped off by the inserting slot to fall into the container.

Synthesizing the all as said above, the advantages of the garlic crusher of the invention are as follows:

1. Two through-hole-matrix metal sheets with different through-hole diameters are provided for selection in order to meet the different requirements of the thickness of the shredded garlic in the garlic mousse;

2. For the inserting mode is adopted for the installation of the through-hole-matrix metal sheet, so that the replacement of the through-hole-matrix metal sheet will become quite convenient.

3. When the processing of garlic mousse is ended, all the garlic mousse remainder on the through-hole-matrix metal sheet will be scrapped off by the inserting slot to fall into the container along with the through-hole-matrix metal sheet being drawn out of the lower pressing piece. Thus the scrapping operation will be quite convenient. Not only the garlic mousse is sanitary, the raw material for preparing the garlic mousse also may be saved.

What is claimed is:

1. A garlic crusher is composed of a upper pressing 1, on which is disposed a pressing block 11, a lower pressing piece 2, on which is disposed a garlic-pressing groove 21 for accepting the pressing block 11, and a through-hole-matrix metal sheet 3. Using a pintle 5, the corresponding ends respectively of said upper pressing piece 1 and said lower pressing piece 2 are connected to be a hinge joint. It is characterized by that said garlic-pressing groove 21 is disposed at one end of said lower pressing piece 2 near said pintle 5 and said garlic-pressing groove 21 is formed by the downward through-aperture on said lower pressing piece 2 and said through-hole-matrix metal sheet 3, which is inserted into said lower pressing piece 2 through an inserting slot 23 to take its position just above a window 22 disposed on the bottom surface of said lower pressing piece 2 and has a great many of through-holes 33 arranged to be a matrix thereon.

2. The garlic crusher as set forth in claim 1, wherein said garlic crusher is characterized by that on said lower pressing piece 2 is disposed a T-shaped slot 27; on said through-hole-matrix metal sheet 3 is disposed a T-shaped tab 31 besides a great many of through-holes 33 arranged to be a matrix thereon; once said T-shaped tab 32 is inserted into said T-shaped slot 27 through an entrance 26 of T-shaped slot 27 for T-shaped tab 32, then said through-hole-matrix metal sheet 3 may be inserted into said lower pressing piece 2 through said inserting slot 23; said T-shaped tab 32 may be moved forward in said T-shaped slot 27 along with said through-hole-matrix metal sheet 3 being pushed forward in said lower pressing piece 2; when said through-hole-matrix metal sheet 3 is pushed to take its operational position and firmly jammed there, a garlic-pressing groove 21 will be formed by the positioned through-hole-matrix metal sheet 3 and the downward through-aperture on said lower pressing piece 2.

3. The garlic crusher as set forth in claim 1, wherein said garlic crusher is characterizes by that at another end of said lower pressing piece 2 far away from said pintle 5 is disposed a storage groove 24 and a clip holder 25; on said clip holder is clamped another one through-hole-matrix metal sheet 3 with a through-diameter other than that of the originally inserted through-hole-matrix metal sheet 3.

4. The garlic crusher as set forth in claim 1, wherein said garlic crusher is characterized that the height of aforesaid inserting slot 23 must be determined in correspondence to the thickness of the through-hole-matrix metal sheet 3, so that both of them may be in a close sliding fit state.

5. The garlic crusher as set forth in claim 2, wherein said garlic crusher is characterized that the height of aforesaid inserting slot 23 must be determined in correspondence to the thickness of the through-hole-matrix metal sheet 3, so that both of them may be in a close sliding fit state.

6. The garlic crusher as set forth in claim 3, wherein said garlic crusher is characterized that the height of aforesaid inserting slot 23 must be determined in correspondence to the thickness of the through-hole-matrix metal sheet 3, so that both of them may be in a close sliding fit state.
